(19) United States
(12) Patent Application Publication
(10) Pub. No.: US 2007/0267529 A1
(43) Pub. Date: Nov. 22, 2007

(54) Clutch Assembly For A Fishing Reel

(75) Inventor: Cameron R. Ivie, Lake Park, IA (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Pure Fishing, Inc., Spirit Lake, IA (US)

(21) Appl. No.: 11/279,462

(22) Filed: Apr. 12, 2006

(51) Int. Cl. A01K 89/02

(52) U.S. Cl. 242/247

(57) ABSTRACT

A clutch assembly is provided that substantially prevents a fishing reel from rotating in one direction. At least one race of a ball bearing assembly is formed integrally with the one-way clutch assembly, thereby improving functional performance by reducing tolerances and aiding in assembly.

### FIELD OF THE INVENTION

The present invention relates to a clutch assembly for a fishing reel. More particularly, the present invention relates to a one-way clutch assembly for a fishing reel including a ball bearing assembly having one of an inner and an outer race formed integrally with its respective sleeve in which the ball bearing assembly is disposed. Integrally forming a race of the clutch assembly with its respective sleeve substantially eliminates variations in concentricity and rotational resistance, thereby facilitating operation of the fishing reel.

### BACKGROUND OF THE INVENTION

One-way clutch assemblies are conventionally used with fishing reels to prevent rotation in a predetermined direction. Typically, a pinion, onto which the rotor is mounted, is constrained by one or more bearings or bushing surfaces located in the reel housing. An inner sleeve is non-rotatably mounted to the outside of the pinion. An outer sleeve is mounted non-rotatably to the housing. A plurality of rollers are located between the inner sleeve and the outer sleeve such that when the clutch is in the “on” position the inner sleeve may only rotate in one direction. Tolerances between the pinion, the pinion mounting bearings, the inner sleeve, the outer sleeve, and the housing may cause variations in the concentricity of the inner and outer sleeves resulting in noise or added resistance to rotation of the pinion, and resulting in a clutch that does not function instantly when in the “on” position.

Examples of existing one-way clutch assemblies for fishing reels are disclosed in the following references: U.S. Pat. No. 5,370,330 to Uehara et al.; No. 5,372,323 to Hirano et al.; No. 5,503,343 to Hirano et al.; No. 6,073,870 to Shinohara et al.; and No. 6,273,351 to Tsukihiji et al. However, none of these patents discloses a ball bearing assembly having one of an inner and an outer race formed integrally with its respective sleeve in which the ball bearing assembly is disposed. Thus, the one-way clutch assemblies of the above-noted patents result in variations in concentricity, increased resistance and inefficient operation as discussed above.

Accordingly, a need exists for a clutch assembly for a fishing reel including a ball bearing assembly having one of an inner and an outer race formed integrally with its respective sleeve in which the ball bearing assembly is disposed, thereby substantially eliminating variations in concentricity and rotational resistance to facilitate operation of the fishing reel.

### SUMMARY OF THE INVENTION

An object of the present invention is to provide a clutch assembly for a fishing reel that reduces the tolerances affecting the assembly of the clutch, thereby improving performance of the fishing reel.

It is a further object of the present invention to provide an integral clutch and bearing assembly to facilitate assembly and testing of the clutch.

The foregoing objectives are attained by providing a fishing reel having a clutch assembly including an inner sleeve, an outer sleeve, a plurality of rollers, and at least one bearing assembly. The outer sleeve is non-rotatably disposed in the reel body. A plurality of rollers are disposed between the inner and outer sleeves such that the rollers may act as a wedge between the two sleeves, thereby substantially preventing rotation of the inner sleeve in one direction. A bearing assembly is located on either side of the plurality of rollers. Each bearing assembly has an outer race, an inner race formed integrally with the inner sleeve, and a plurality of balls disposed therebetween.

Integrating a race of a bearing assembly with its respective sleeve reduces the number of tolerances involved during the manufacturing process, thereby ensuring better alignment of the bearing assemblies with the clutch assembly and the pinion. This ensures smoother and more efficient turning and stopping of the pinion. Furthermore, integrating the races of the bearing assemblies allows the bearings to capture the clutch assembly, thereby facilitating assembly and testing of the clutch assembly. Integrating the outer races of the bearing assemblies with their respective sleeves further reduces the number of manufacturing tolerances, thereby further facilitating the above-noted advantages.

Other objects, advantages, and salient features of the invention will become apparent from the detailed description, which, taken in conjunction with the annexed drawings, discloses preferred exemplary embodiments of the invention.

### BRIEF DESCRIPTION OF THE DRAWINGS

The above aspect and other features of the present invention will become more apparent by describing in detail exemplary embodiments thereof with reference to the attached drawing figures, wherein;

FIG. 1 is a cutaway view in partial cross section of the clutch assembly disposed in a spinning reel according to an exemplary embodiment of the present invention;

FIG. 2 is a perspective view of the clutch assembly according to an exemplary embodiment of the present invention;

FIG. 3 is a front elevational view in cross section of the clutch assembly according to an exemplary embodiment of the present invention;

FIG. 4 is a side elevational view in cross section of the clutch assembly taken along a longitudinal axis;

FIG. 5 is a rear elevational view of the clutch assembly in the “off” position;

FIG. 6 is a rear elevational view of the clutch assembly in the “on” position; and

FIG. 7 is a rear elevational view of the clutch assembly including an elastic member to bias the clutch assembly in an “on” position.

Throughout the drawings, like reference numerals will be understood to refer to like parts, components and structures.

### DETAILED DESCRIPTION OF EXEMPLARY EMBODIMENTS

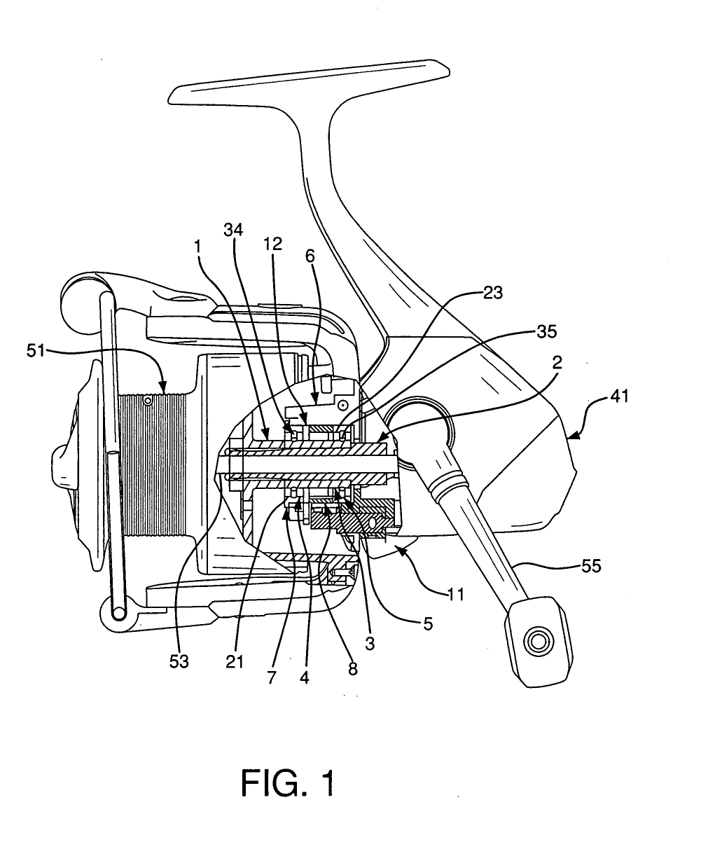

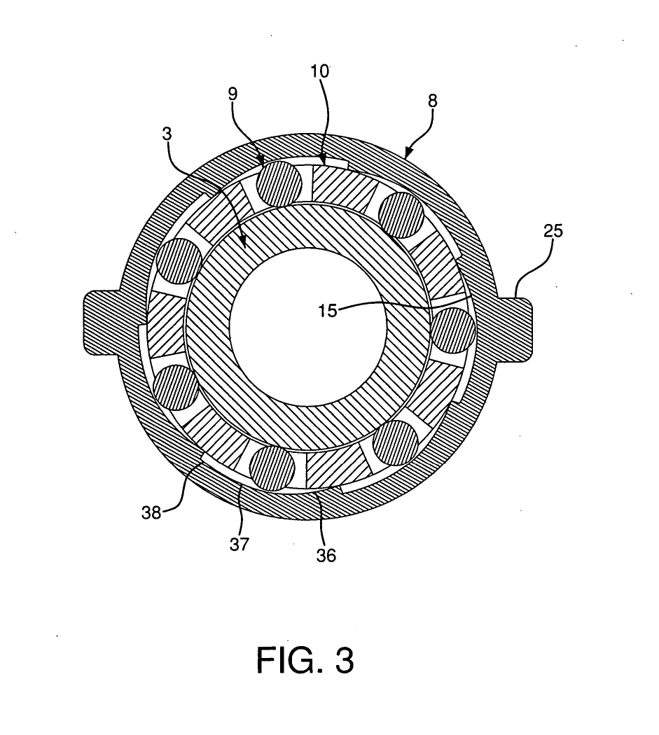

FIGS. 1-7 show a clutch assembly 31 of a spinning reel 41 for fishing according to exemplary embodiments of the present invention. In the spinning reel 41, a rotor 1 is fixedly secured to a pinion 2, which is geared to a drive gear mounted on a handle shaft. An inner sleeve 3 is non-rotatably fitted onto the pinion. An outer sleeve 8 has keys 25 so as to be non-rotatable with respect to the reel body 6. A plurality of rollers 9 are placed between the inner sleeve 3 and the outer sleeve 8 in a pin holder 10, as shown in FIG. 3.

Spinning reels 41 for fishing have a spindle 53 that is axially displaceable and mounted in a housing 6. A line spool 51 is carried at one end thereof and secured in place with various forms of releasable attachments. The line spool 51 is rotatably connected to the spindle and is axially fixed thereon. A drive shaft extending at right angles to the spindle 53 is mounted in the housing 6 to be rotated by a handle 55. Oscillating means are connected to the drive shaft and the spindle 53. When the handle 55 is rotated for retrieving a fishing line fixed on the line spool 51, the drive shaft rotates and drives the oscillating means, in turn oscillating the spindle 53, and hence the line spool 51, in the longitudinal direction of the spindle. Through a gear transmission provided in the housing, the handle drives a pinion 2 integrally formed with a hollow shaft that projects from the housing and is coaxial with the spindle 53 extending through the shaft. A rotor assembly 1 is fixedly mounted to the pinion 2. By such a system, the drive handle 55 is coupled to the spool 51 to provide axial oscillation without rotation, and is coupled to the rotor assembly 1 to provide rotation about the spool axis.

The rotor assembly 1 is made with a housing 6 and a bail system laterally positioned and pivotably mounted thereto. With the bail system in the “closed” position, tensioned line extending between the spool and the line guides is directed laterally into a smooth groove of a roller guide that is disposed on the bail arm. By rotating the rotor assembly 1 in one direction, the line is rotated around and wound onto the axially oscillating spool 51. Line under tension applies a rotational force to the rotor assembly 1 in the unwinding direction, and may be unwound from the spool 51 by rotating the rotor assembly in this direction. The bail system is placed in the “open” position to disengage the bail system from the line and allow the line to flow freely off the spool 51 as is needed when casting.

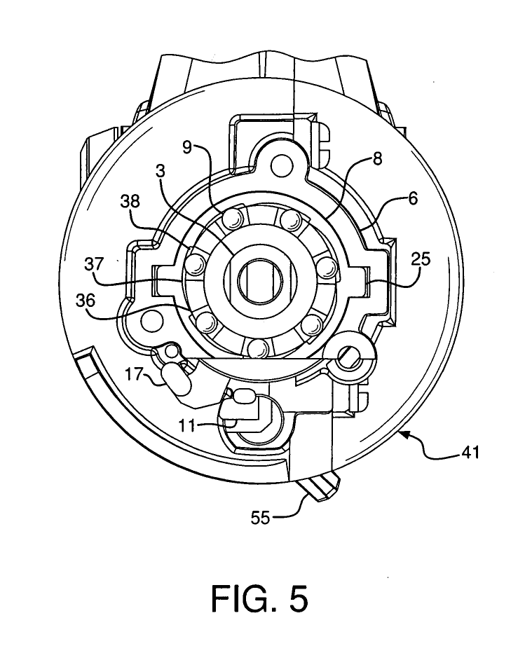

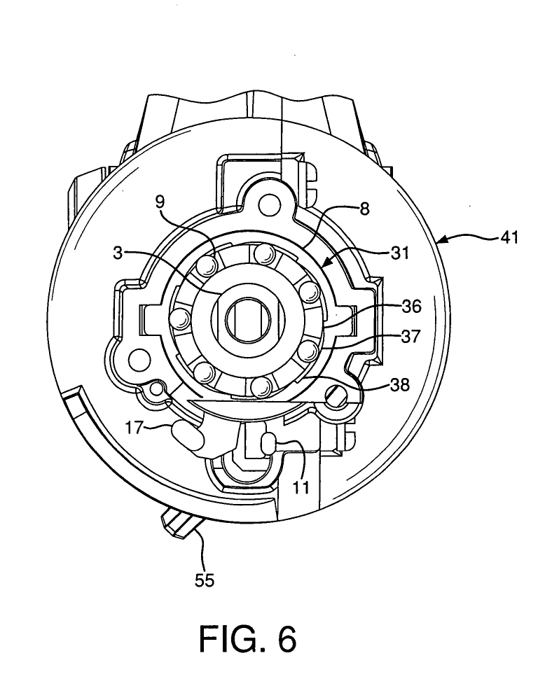

The spinning reel 41 has a clutch assembly 31 disposed on the pinion 2. The clutch assembly 31 has an engaged or “on” state (FIG. 6) that allows the rotor assembly 1 to rotate only in the line retrieval direction. The disengaged or “off” state of the clutch assembly (FIG. 5) allows the rotor assembly 1 to rotate in either the winding direction or an unwinding direction. A switch, lever or similar type of selector is usually provided for selecting between these two states of the clutch assembly 31. With the clutch in the “on” state, tension in the fishing line is prevented from rotating the rotor in an unwinding direction.

The spool 51 is mounted to the reel through a drag system that employs a series of draw washers to permit a frictionally retarded rotation about the spindle axis. Inter-washer friction is adjusted and is smoothly variable by compression forces from a threaded drag knob, dial, ring, or lever. The amount of friction applied is adjustable by the angler so that, should the tension in the fishing line exceed the frictional force of the drag system, the spool will rotate to release line and prevent the line from breaking. An angler may also place the clutch in the “off” state and allow the rotor assembly to rotate in the unwinding direction to release line.

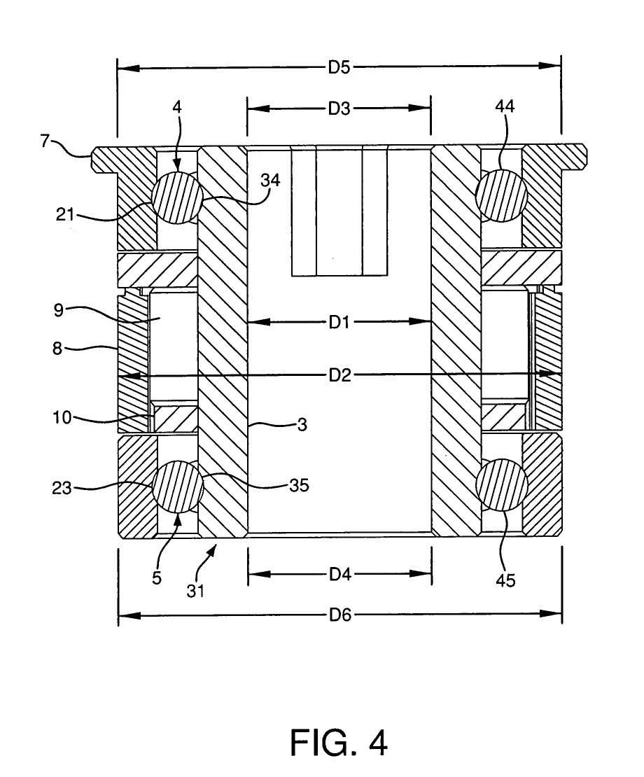

The pinion 2 onto which the rotor assembly 1 is mounted is constrained by one or more bearings or bushing surfaces located in the reel housing 6. An inner sleeve 3 having an inner diameter D1 (FIG. 4) is non-rotatably mounted to the outside of the pinion 2. An outer sleeve 8 having an outer diameter D2 (FIG. 4) is mounted non-rotatably to the body housing 6. A plurality of rollers 9 are located in a pin holder 10 between the inner sleeve 3 and the outer sleeve 8 such that when the clutch assembly is in the “on” position the inner sleeve 3 may only rotate in one direction.

A switch 11 moves the pin holder 10 between an “on” position (FIG.6) that is biased so that the rollers 9 act as a wedge between the inner sleeve 3 and the outer sleeve 8 such that the inner sleeve is substantially prevented from rotating in one direction, and an “off” position (FIG. 5) such that the inner sleeve may rotate in both directions. A plurality of grooves 37 having a first end 36 and a second end 38 are disposed in an inner surface 15 of the outer sleeve 8. The first end 36 of the groove 37 has a smaller radius with respect to the center of the outer sleeve 8 than the second end 38 of the groove.

Moving the switch 11 to the “off” position causes the switch to engage the lever 17, which is connected to the pin holder 10, thereby rotating the pin holder clockwise as shown in FIG. 5. When the clutch assembly 31 is in the “off” position, the rollers 9 are positioned proximal the second ends 38 of the grooves 37, thereby allowing rotation in both the clockwise and counterclockwise directions.

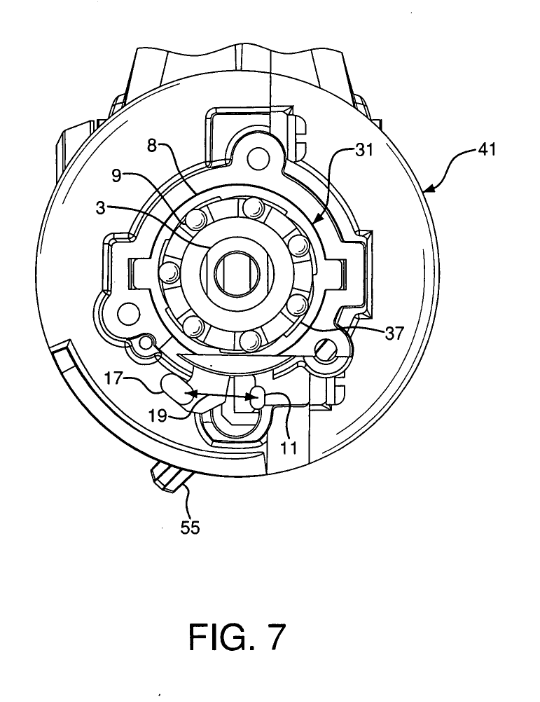

In the “off” position, the rollers 9 allow the inner sleeve 3 to rotate in either the clockwise or counterclockwise direction. Moving the lever 17 to rotate the pin holder 10 to the “on” position moves the rollers 9 toward the first end 36 of the groove 37, thereby preventing rotation of the inner sleeve 3 in the counterclockwise direction as shown in FIG. 6. In the “on” position, the inner sleeve 3 is prevented from rotating in the counterclockwise direction because the rollers 9 are wedged proximal the first ends 36 of the grooves 37, thereby preventing rotation in the counterclockwise direction. An elastic member 19, such as a spring, is connected between the switch 11 and the lever 17 to bias the pin lever toward the lever to maintain the clutch assembly in the “on” position, as shown in FIG. 7.

A first ball bearing assembly 4 and a second ball bearing assembly 5 are disposed at each end of the inner sleeve 3, respectively, as shown in FIG. 3. Each ball bearing assembly has an inner race 34 and 35, respectively, an outer race 21 and 23, respectively, and a plurality of balls 44 and 45, respectively, disposed therebetween such that each outer race is axially fixed with respect to the respective inner race, i.e., the first outer race 21 is axially fixed with respect to the first inner race 34 and the second outer race 23 is axially fixed with respect to the second inner race 35. The inner races 34 and 35 of each ball bearing assembly 4 and 5 are preferably integrally formed on the inner sleeve 3 and have inner diameters D3 and D4, respectively, as shown in FIG. 4. The outer races 21 and 23 of each ball bearing are preferably integrally formed with the outer sleeve 8 and have outer diameters D5 and D6, respectively, as shown in FIG. 4. A flange 7 of the first ball bearing is axially mounted to the reel body 6.

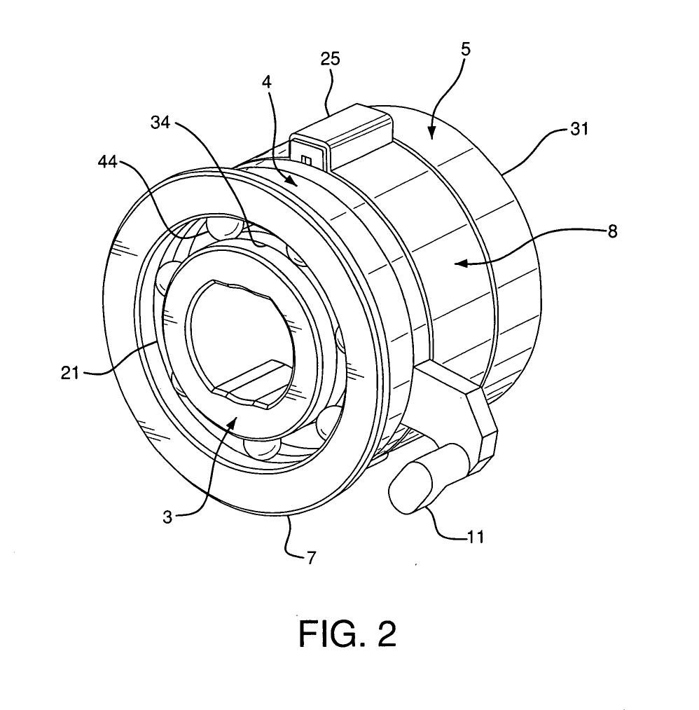

In an exemplary embodiment of the present invention, an outer diameter D5 of an outer race of a bearing assembly and the outer diameter D2 of the outer sleeve 8 are substantially equal, as shown in FIGS. 2 and 4. Preferably, the outer diameters D5 and D6 of the first and second outer races 21 and 23 are substantially equal to the outer diameter D2 of the outer sleeve. Preferably, an inner diameter D3 of an inner race of a bearing assembly is substantially equal to an inner diameter D1 of the inner sleeve 3. Preferably, the inner diameters D3 and D4 of the first and second inner races 34 and 35 are substantially equal to the inner diameter D1 of the inner sleeve 3.

The reel body 6 has a bore 12 that may be formed or machined with a high tolerance to a single diameter to radially constrain the outer race of each ball bearing assembly 4 and 5 and the outer sleeve 8 of the clutch assembly 31. Thus, the concentricity of the inner sleeve 3 and the outer sleeve 8 are well maintained through the ball bearing assemblies 4 and 5. Also, the entire clutch assembly 31 is self-contained, thereby aiding in assembly and allowing the entire clutch assembly to undergo testing prior to assembly with the fishing reel.

Variations in the tolerances between the pinion 2, the pinion mounting bearings, the inner sleeve 3, the outer sleeve 8, and the body housing 6 are substantially eliminated by integrally forming at least one race of a bearing assembly with its respective sleeve, thereby substantially eliminating noise and pinion rotational resistance to facilitate operation of the clutch assembly. Integrating a race of a bearing assembly reduces the number of tolerances involved during manufacturing of the parts, thereby ensuring better alignment of the bearing assemblies with the clutch assembly and the pinion. This ensures smoother and more efficient turning and stopping of the pinion 2. Furthermore, integrating the races of the bearing assemblies allows the bearings to capture the clutch assembly, thereby facilitating assembly and testing of the clutch assembly. Integrating the outer races further reduces the number of manufacturing tolerances, thereby further facilitating the above-noted advantages. Conventionally, non-integrated races for bearing assemblies required several different diameters throughout the clutch assembly such that many different manufacturing tolerances were required, thereby causing variations in the concentricity of the inner and outer sleeves resulting in noise or added resistance to rotation of the pinion, and resulting in a clutch assembly that does not function instantly when in the “on” position.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A clutch assembly for a fishing reel, comprising:
an outer sleeve;
an inner sleeve;
a plurality of rollers disposed between said inner and outer sleeves adapted to substantially prevent said inner sleeve from rotating in one direction; and
a first ball bearing assembly having an inner race formed integrally with said inner sleeve, an outer race, and a plurality of balls disposed therebetween.

2. A clutch assembly according to claim 1, wherein
an outer diameter of said first bearing outer race and an outer diameter of said outer sleeve are substantially equal.

3. A clutch assembly according to claim 1, wherein
a switch moves said clutch assembly between an “on” position in which said inner sleeve is substantially prevented from rotating in one direction and an “off” position in which said inner sleeve is able to rotate in both directions.

4. A clutch assembly according to claim 3, wherein
an elastic member biases said switch in said “on” position.

5. A clutch assembly according to claim 1, wherein
a second ball bearing assembly has an inner race formed integrally with said inner sleeve.

6. A clutch assembly according to claim 5, wherein
an outer diameter of said outer race of one of or both said first and second bearing assemblies is substantially equal to an outer diameter of said outer sleeve.

7. A clutch assembly according to claim 1, wherein
said outer race of said first ball bearing assembly is formed integrally with said outer sleeve.

8. A clutch assembly according to claim 5, wherein
said outer race of one of or both said first and second ball bearing assemblies is formed integrally with said outer sleeve.

9. A clutch assembly for a fishing reel, comprising:
an outer sleeve;
an inner sleeve;
a plurality of rollers disposed between said inner and outer sleeves adapted to substantially prevent said inner sleeve from rotating in one direction; and
a first ball bearing assembly having an outer race formed integrally with said outer sleeve, an inner race, and a plurality of balls disposed therebetween.

10. A clutch assembly according to claim 9, wherein
an inner diameter of said first ball bearing inner race and an inner diameter of said clutch inner sleeve are substantially equal.

11. A clutch assembly according to claim 9, wherein
a switch moves said clutch assembly between an “on” position in which said inner sleeve is substantially prevented from rotating in one direction and an “off” position in which said inner sleeve is able to rotate in both directions.

12. A clutch assembly according to claim 11, wherein
an elastic member biases said switch in said “on” position.

13. A clutch assembly according to claim 9 wherein
a second ball bearing assembly has an outer race formed integrally with said outer sleeve.

14. A clutch assembly according to claim 13, wherein
an inner diameter of said inner race of one of or both said first and second ball bearing assemblies is substantially equal to an inner diameter of said inner sleeve.

15. A clutch assembly according to claim 9 wherein
said clutch assembly is disposed in a spinning reel.

16. A clutch assembly for a fishing reel, comprising:
an outer sleeve;
an inner sleeve;
a plurality of rollers disposed between said inner and outer sleeves adapted to substantially prevent said inner sleeve from rotating in one direction; and
a first ball bearing assembly having an inner race, an outer race, and a plurality of balls disposed therebetween, at least one of said inner and outer races being formed integrally with said respective sleeve of said clutch assembly.

17. A clutch assembly according to claim 16, wherein
an outer diameter of the bearing outer race and an outer diameter of said clutch outer sleeve are substantially equal.

18. A clutch assembly according to claim 16, wherein
a switch moves said clutch assembly between an “on” position in which said inner sleeve is substantially prevented from rotating in one direction and an “off” position in which said inner sleeve is able to rotate in both directions.

19. A clutch assembly according to claim 18, wherein
an elastic member biases said switch in said “on” position.

20. A clutch assembly according to claim 16, wherein
a second ball bearing assembly has at least one of an inner and outer race formed integrally with one of said inner and outer clutch sleeves, respectively.

21. A clutch assembly according to claim 19, wherein
an outer diameter of said outer race of one of or both said first and second ball bearing assemblies is substantially equal to an outer diameter of said outer sleeve.

22. A clutch assembly according to claim 16 wherein
said clutch assembly is disposed in a spinning reel.

23. A spinning reel for fishing, comprising:
a body;
a clutch assembly disposed in said body, said clutch assembly including
an outer sleeve;
an inner sleeve;
a plurality of rollers disposed between said inner and outer sleeves adapted to substantially prevent said inner sleeve from rotating in one direction; and
a first ball bearing assembly having inner and outer races and a plurality of balls disposed therebetween, at least one of said inner and outer races being formed integrally with said respective sleeve.

24. A spinning reel according to claim 23, wherein
an outer diameter of said bearing outer race and an outer diameter of said clutch outer sleeve are substantially equal.

25. A spinning reel according to claim 23, wherein
a switch moves said clutch assembly between an “on” position in which said inner sleeve is substantially prevented from rotating in one direction and an “off” position in which said inner sleeve is able to rotate in both directions.

26. A spinning reel according to claim 23, wherein
an elastic member biases said switch in said “on” position.

27. A spinning reel according to claim 23, wherein
a second ball bearing assembly has at least one of an inner and outer race formed integrally with one of said inner and outer clutch sleeves, respectively.

28. A spinning reel according to claim 27, wherein
an outer diameter of said outer race of one of or both said first and second ball bearing assemblies is substantially equal to an outer diameter of said outer sleeve.

29. A spinning reel for fishing having a clutch assembly disposed in a body, a pinion is non-rotatably received by an inner sleeve of the clutch assembly, a line spool axially disposed on a spindle and rotatably connected thereto, and the spindle is connected to the pinion that is driven by a handle shaft, the improvement comprising:
a clutch assembly including
an outer sleeve;
the inner sleeve; and
a plurality of rollers disposed between the inner and outer sleeves adapted to substantially prevent the inner sleeve from rotating in one direction; and
a first ball bearing assembly having inner and outer races and a plurality of balls disposed therebetween, at least one of the inner and outer races being formed integrally with the respective sleeve.

30. A spinning reel according to claim 29, wherein
an outer diameter of the bearing outer race and an outer diameter of the clutch outer sleeve are substantially equal.

31. A spinning reel according to claim 29, wherein
a switch moves the clutch assembly between an “on” position in which the inner sleeve is substantially prevented from rotating in one direction and an “off” position in which the inner sleeve is able to rotate in both directions.

32. A spinning reel according to claim 31, wherein
an elastic member biases the switch in the “on” position.

33. A spinning reel according to claim 29, wherein
a second ball bearing assembly has at least one of an inner and outer race formed integrally with one of the inner and outer clutch sleeves, respectively.

34. A spinning reel according to claim 33, wherein
an outer diameter of the outer race of one of or both the first and second ball bearing assemblies is substantially equal to an outer diameter of the outer sleeve.
